(19) United States
(12) Patent Application Publication
(10) Pub. No.: US 2001/0032151 A1
(43) Pub. Date: Oct. 18, 2001

(54) Internet presentation system

(76) Inventors: Glenn Paul, Titusville, NJ (US); Walter J. Krieg, Princeton, NJ (US)

Correspondence Address: Richard C. Woodbridge, Esquire, Woodbridge & Associates, P.C., P.O. Box 592, Princeton, NJ, 08542-0592, US

(21) Appl. No.: 09/837,392

(22) Filed: Apr. 18, 2001

Related U.S. Application Data
(60) Provisional application No. 60/198,098, filed on Apr. 18, 2000.

(51) Int. Cl. G06F 17/60

(52) U.S. Cl. 705/26

(57) ABSTRACT

A software system for use on the Internet that allows users to create business presentations and personal slide shows using both pictures and audio input from a microphone on the user's local PC. The pictures and audio are stored on the web site, and the site provides feedback to the creator about who has viewed the presentation. Use of the local PC's recording capability eliminates the need for audio streaming and allows the process to be practiced over a low bandwidth internet connection.

### CROSS REFERENCE TO RELATED APPLICATIONS

This application is a non-provisional application based on U.S. provisional application 60/198098 entitled “Internet Presentation System” filed with the USPTO on Apr. 18, 2000.

### BACKGROUND OF THE INVENTION

1. Field of the Invention

This invention relates to an Internet presentation system which allows users to create business presentations and personal slide shows using pictures, text and audio input from a microphone on the user's PC.

2. Description of Related Art

Currently web sites are available that enable users to add a limited number of predetermined sounds to pictures that have been uploaded to the web site. These require the user to access an external hardware system such as a telephone or to purchase special sound files created in a studio by a third-party and added to the site by installing HTML text. The disclosed invention is the easiest and most straightforward way to add voice to a picture because it requires only a local microphone attached to a PC, and automatically associates the voice or sound with the photo page without the addition of any special software coding.

Examples:

http://www.a2dvoices.com/demo/

A2Dvoices.com

This site creates professional demo voices for a fee that can be added to a web site by installing software code.

http://www.photopoint.com//promotions/20010405.htm1

PhotoPoint Voice Enabled E-mail

Requires a special camera to add voice to e-mail. E-mail recipients must have Shockwave installed to hear the sound.

http://www.adobe.com/store/products/livemotion.htm1

Adobe Livemotion Software

This software product creates web sites with sound, but requires the purchase of the product to create a unique web site with sounds that can only be edited through sophisticated software tools. It does allow users to create their own presentations on a third-party web site.

### BRIEF SUMMARY OF THE INVENTION

This invention relates to an Internet presentation system that allows users to create business presentations and personal slide shows using both pictures and audio input from a microphone on the user's local PC. The pictures are uploaded to the website and presented in the form of an album. The sound file associated with each picture is created on the user's local PC with the PC's microphone and then uploaded to the web site. Each audio file is associated with the picture chosen by the user. The pictures and audio are stored on the web site and may be accessed by individuals who wish to view the pictures and listen to the audio, and the site provides feedback to the creator about who has viewed the presentation. Production of the sound file using the local PC's microphone and related circuitry eliminates the need to stream the audio to the web site for recording. Local production of the audio file reduces the amount of bandwidth required for the Internet connection to the web site since bandwidth is not consumed by streaming sound back and forth between the client server and the client. Once the photos and sounds are uploaded to the web site, the order of the pictures and sounds (now integrated as a single “slide”) can be rearranged (re-ordered) for the appropriate “flow” of the presentation. Once the presentation is complete, it can be viewed in “Presentation” mode, which is a special screen that does not include editing buttons and other extraneous on-screen information. Presentation View displays buttons for viewing the presentation including “Previous”, “Next”, “Zoom” and, if sound has been added, “Play Sound.” The creator of the presentation can also e-mail an automatically coded link to another user who, upon clicking on the link, can view the presentation without logging into the site or downloading any special software. (The only software required to use these features are Microsoft Internet Explorer and Microsoft Media Player, two of the most popular desktop applications for the Internet.) Viewers of the presentation can respond to the presentation by e-mailing a message to the creator of the presentation.

The present invention recognizes that the image is just a part of a complete presentation system incorporating sound, text, images, and feedback from people who view the presentation.

### BRIEF DESCRIPTION OF THE SEVERAL VIEWS OF THE INVENTION

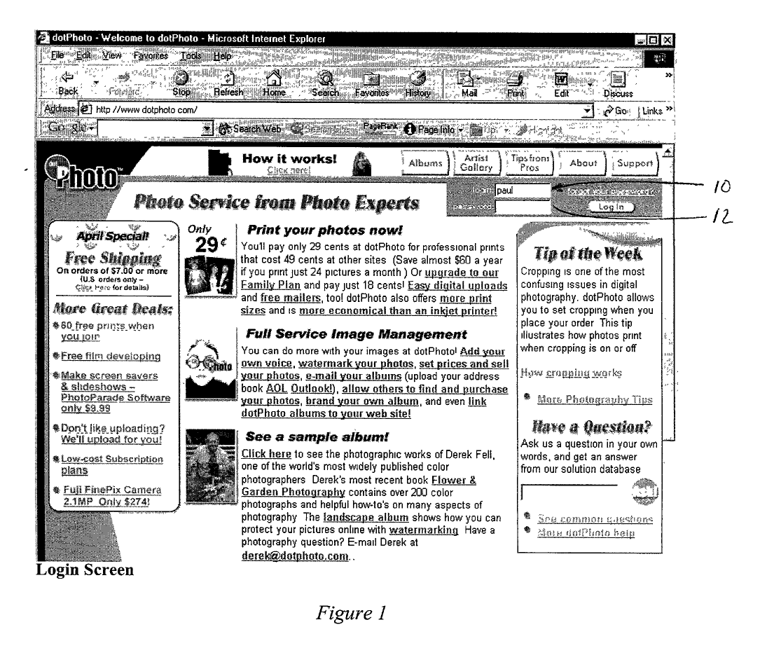

FIG. 1 shows the log in screen where either a creator or a viewer may log in for access to a photo album or business presentation.

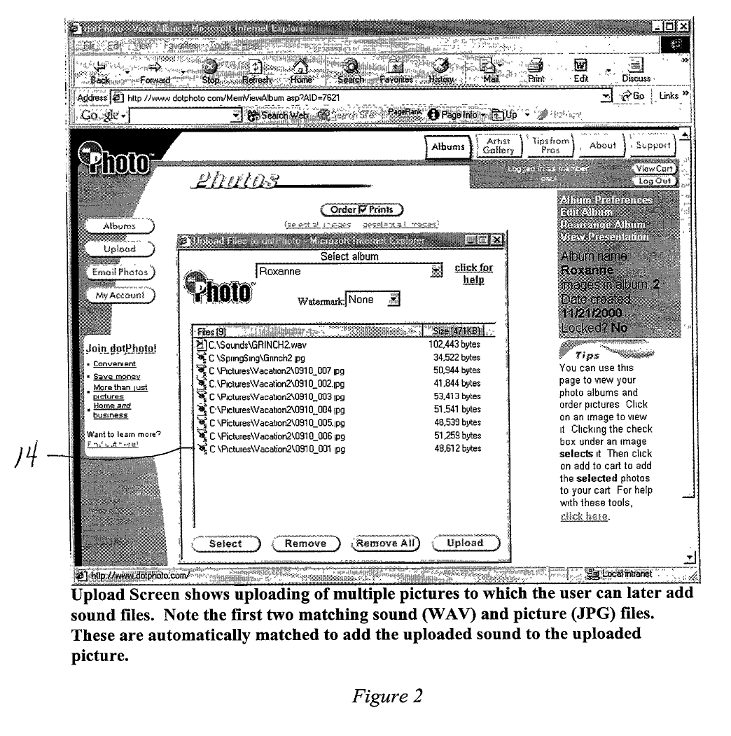

FIG. 2 shows the upload screen where creator users can specify which pictures are uploaded to the web site.

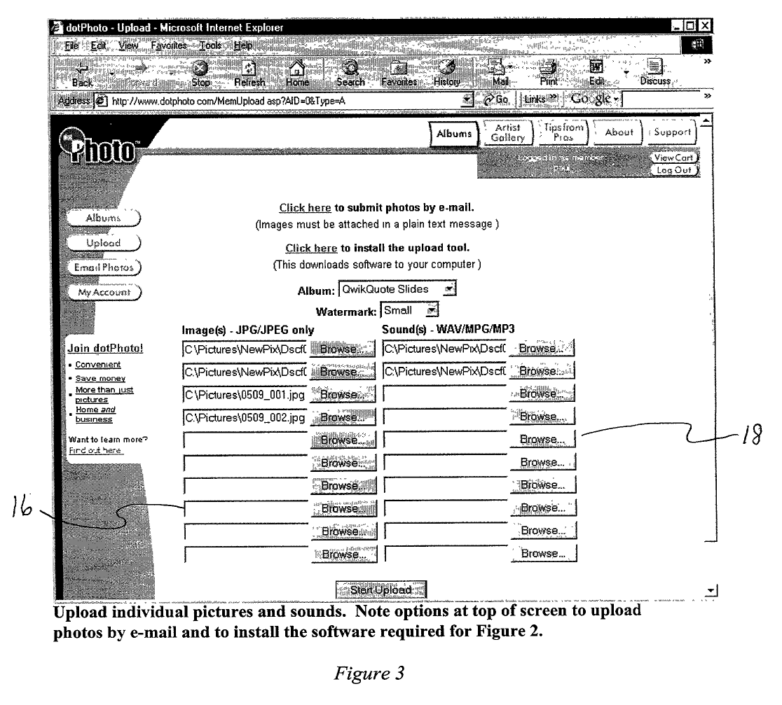

FIG. 3 shows the screen, which allows creator users to upload individual pictures and sound.

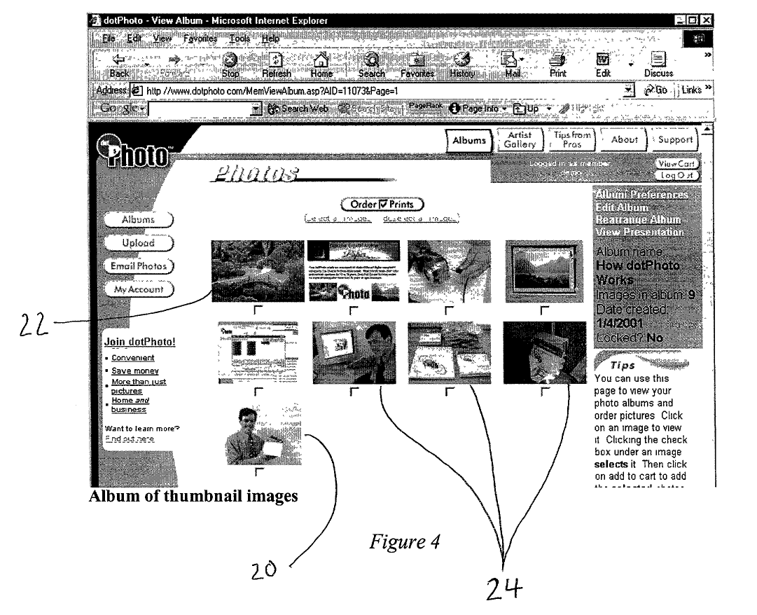

FIG. 4 shows a photo album.

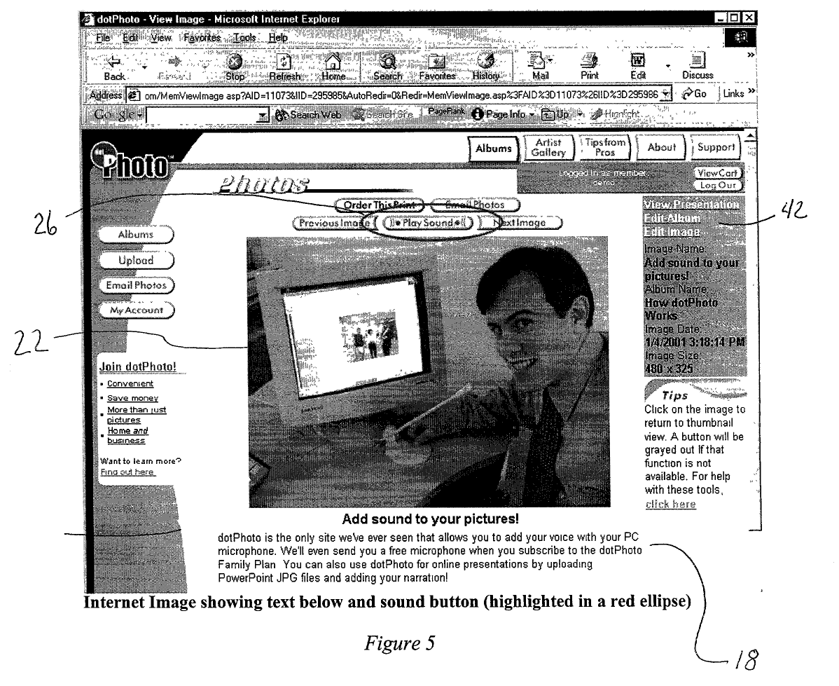

FIG. 5 shows an individual Internet Image with sound control.

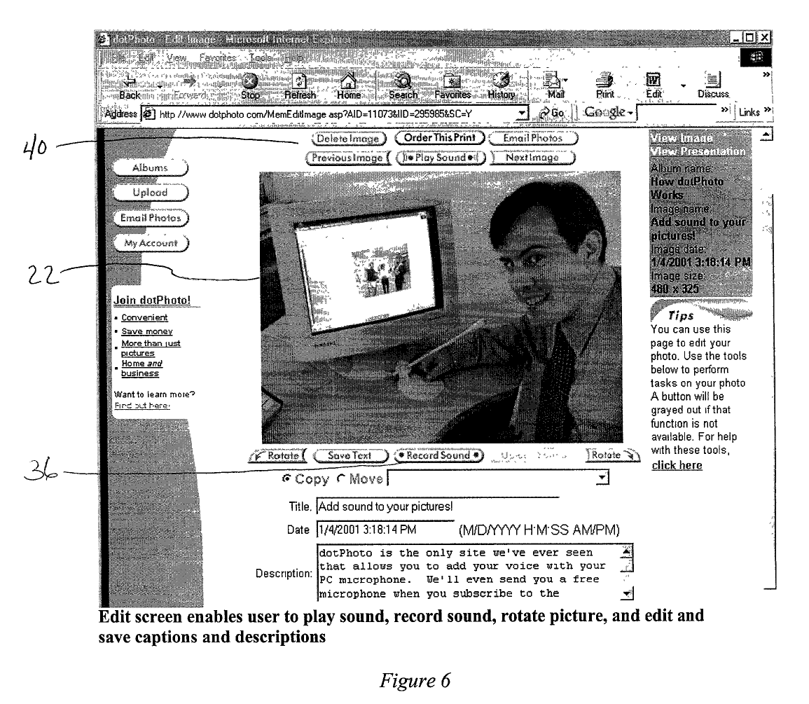

FIG. 6 shows the edit screen, which enables a user to play sound, record sound rotate pictures and edit and save captions and pictures.

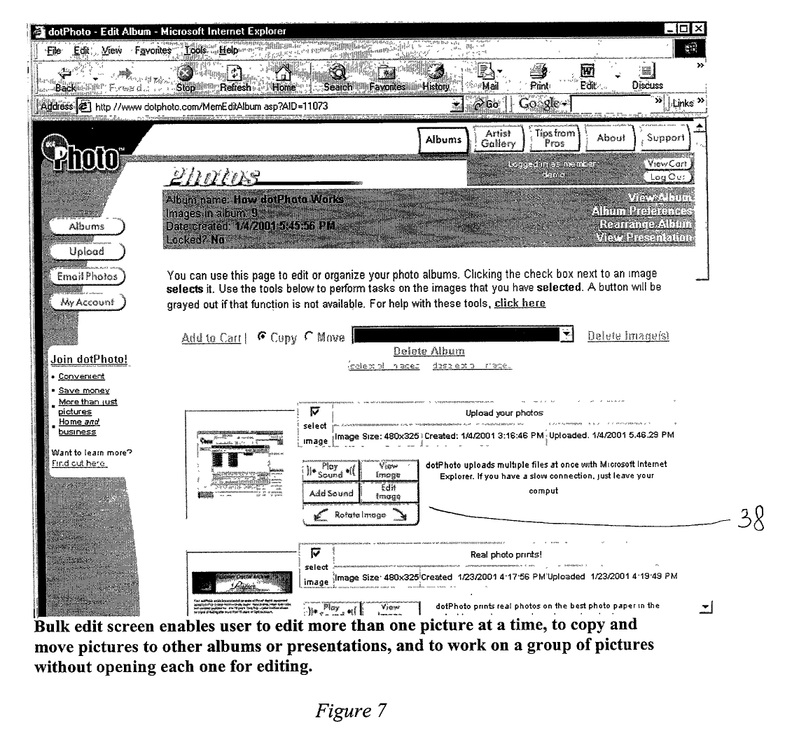

FIG. 7 shows a bulk edit screen where more than one image and sound file may be edited at one time.

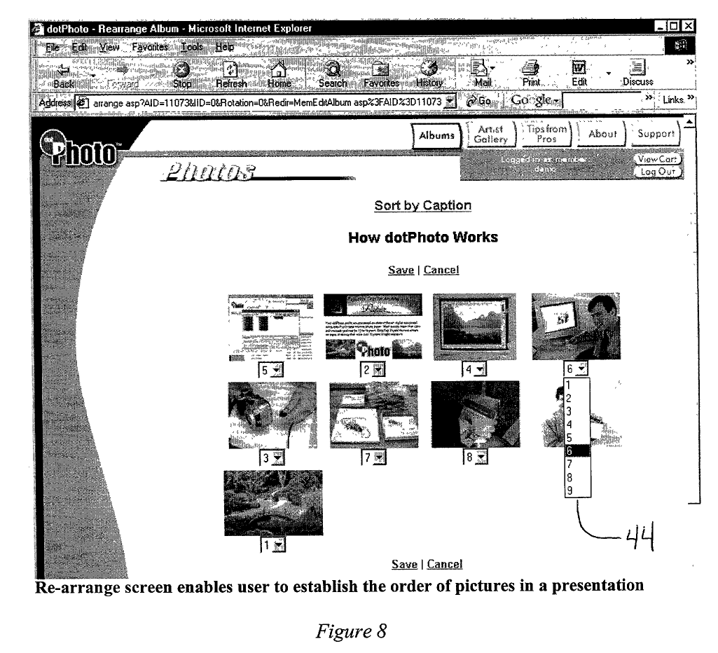

FIG. 8 shows the re-arrange screen.

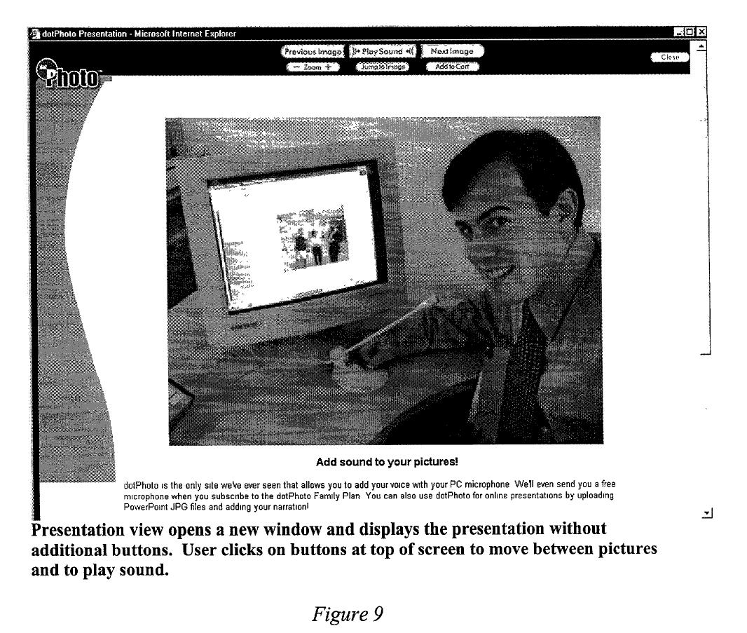

FIG. 9 shows the presentation view without additional buttons.

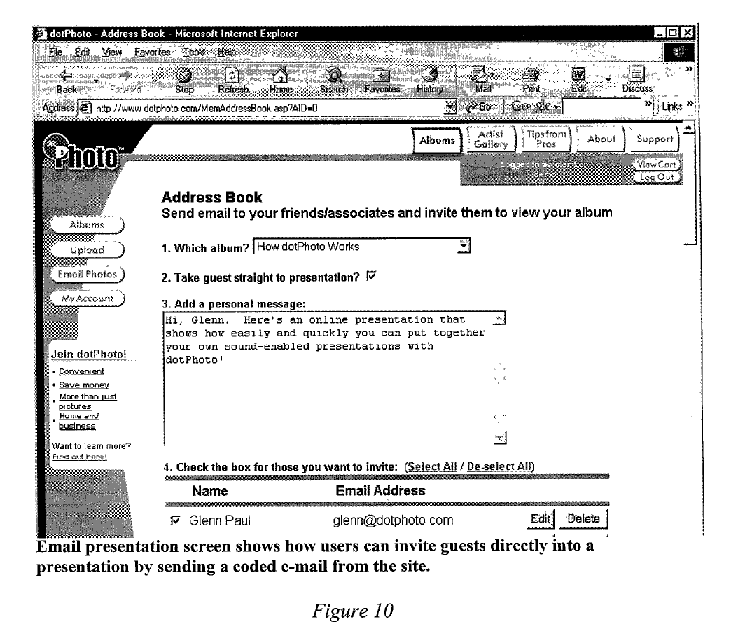

FIG. 10 shows the E-mail presentation screen.

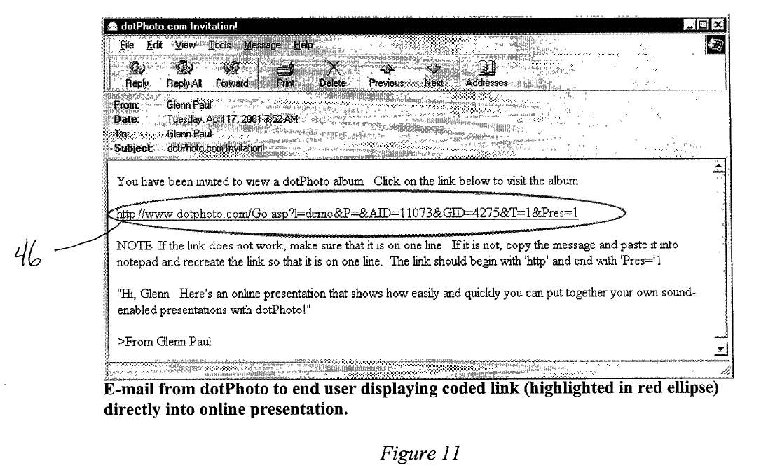

FIG. 11 shows an example e-mail, which contains the coded URL link.

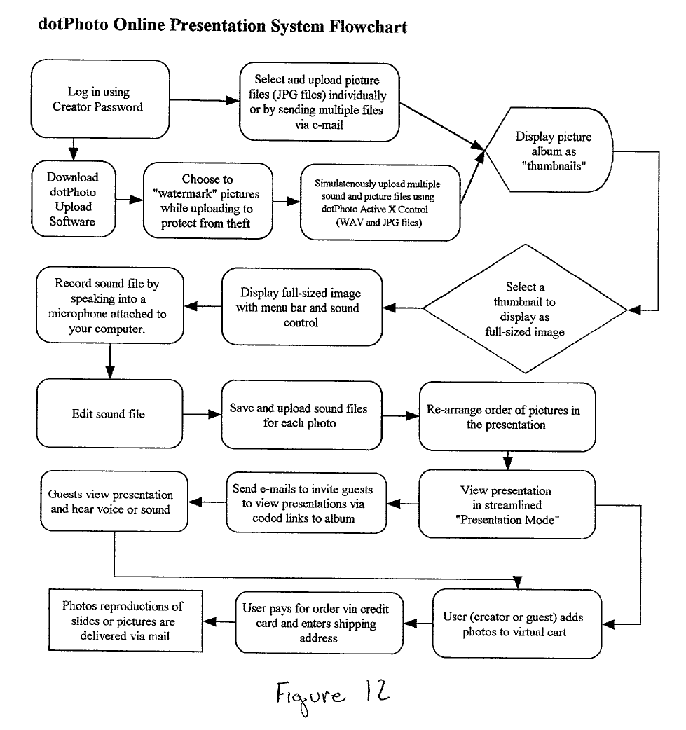

FIG. 12 shows a flow chart for the method.

### DETAILED DESCRIPTION OF THE INVENTION

During the course of the description, like numbers will be used to identify the like elements according to the different views, which illustrate the invention.

A preferred embodiment of the invention consists of gaining access to the Internet, which allows a remote user 10 to log on to a web site FIG. 1 with a “Creator” password 12. This password 12 allows the user to create and modify data contained in the web site file. Inside the site, the Creator can also establish a “Viewer” password, which allows other remote users who know the password to view the secured files, but not to modify the pictures, text, or sound contained in the files. Under the Creator password 12, the user 10 can add pictures to an album 24 or presentation 24 by uploading multiple files 16 FIG. 2 simultaneously by using an Active X control that uploads to the web site. Alternatively, the user can select a picture 16 and sound file 18 FIG. 3 to load simultaneously by selecting individual files to be e-mailed to the web site.

Most pictures are too large to display on a computer screen. As a picture is uploaded, its original image is saved, and the picture is also saved in two other formats: (a) as a small “thumbnail” 20 FIG. 4 representation of the original image and (b) a larger “Internet image” 22 FIG. 5. that is displayed when a user 12 places a cursor over a thumbnail image 20 and clicks on the thumbnail image 20.

The thumbnail images 20 are displayed in an “album” 24 which may be a group of unrelated images or a group of images related to one another, as in a business presentation. Clicking on one of the thumbnail images 20 displays the “Internet image” 22 and the text and sound that are associated with that image 22. A play sound control bar 26 FIG. 5 also pops up with the Internet image 22 and is displayed in the screen with the image 22. The text 18 and sound may simply describe the individual image 22 or help tell the story of the presentation or album 24. Users 10 can click on the play sound button 26 to hear the sound that is associated with the image 22.

Above the Internet image 22 is displayed a list of choices 40 one of which can be selected by placing a cursor over the choice and clicking. The choices that may be used are: (a) Delete Image, (b) Order this Print, (c) E-mail Photos, (d) Previous Image, (e) Play Sound, and (f) Next Image in FIG. 5.

Clicking on the Delete Image button deletes the image, clicking on the Order this Print button allows the user to order a hard copy of the print, clicking on the e-mail Photos allows the user to e-mail electronic copies of the pictures in the album. The remaining buttons are self explanatory.

Next to the Internet Image 22, there is an additional set of choices 42. These are View presentation, Edit Album, Edit Image.

Clicking on the “Edit Image” choice, for example, brings up a custom control bar 36 FIG. 6 that allows the user 10 to, Record a sound, Save Text, Upload a sound or rotate a picture. Clicking on the “Record” button 36 allows the user 10 to record a sound using a microphone and a sound card on the local computer. The user 10 can click the “Upload Sound” button to upload the sound file to the web site. The sound is then associated with the image in the web site database and is available to playback when another user, who has access through the “Viewer” password, views the image 22. Text can be added by typing it into the title and description boxes and clicking on the “Save Text” button.

FIG. 7 shows a page that contains a control bar that allows simultaneous editing of more than one picture at a time and allows users to copy, move pictures to other albums, and to work on a group of pictures without opening each one for editing.

FIG. 8 shows a view of the album with a dialog box that drops down to reveal numbers. A user can choose a number to rearrange the order in which the pictures are displayed.

FIG. 9 is a representation of the presentation view of an internet image. This opens a new view which does not contain additional buttons.

The creator of a slide show or presentation often desires to get feedback from the viewers of the slide show or presentation. The web site allows a client to create a photo album or presentation and then invite guests to view a presentation by sending an e-mail to the guest, which has a coded link, FIG. 10. The disclosed web site will generate and e-mail an invitation to view the presentation which contains the coded link in the form of a unique web URL address 46, FIG. 11 to each guest viewer of the presentation. Under this arrangement, when a guest viewer links to the presentation, by clicking on the URL link 46, the web site alerts the “Creator” of the presentation that the guest viewer has seen the presentation. This feature is especially useful for business presentations in that it allows the creator of the presentation to keep track of which clients, or customers are viewing the presentation and allows the creator to follow up on these clients.

Another feature of the invention is that users can order physical prints of the images 22 in 5″×7″ or 8″×10″ formats through an online photo ordering and printing system. An order is placed by clicking on the “Order this Print” selection in the control bar 40 above the Internet Image 22.

Yet another feature of the invention is that users can order miniature sound playback devices attached to the picture, which contain the audio file associated with the picture. This feature is especially attractive for use with picture albums because it allows a family member who lives across the country to order a copy of a picture with the associated sound file.

FIG. 12 shows a flow chart of the process of creating a picture album or business presentation.

We claim:

1. A method of producing and viewing an audio-visual presentation under the control of a client system for access by creator clients and guest clients, said method comprising:
(a) displaying the visual elements of said audio-visual presentation;
(b) recording the audio elements of said audio-visual presentation at a site remote from said client system;
(c) uploading said audio elements of said audio-visual presentation to said client system;
(d) associating each of said audio elements with a corresponding visual element;
(e) generating a text file containing the text elements of said audio-visual presentation at a site remote from said client system;
(f) uploading said text elements of said audio-visual presentation to said client system; and,
(g) displaying said visual, text and associated audio elements for playback;
whereby both said audio, visual and text elements of said audio-visual presentation may be viewed and heard respectively by a client.

2. The method of claim 1 comprising the additional step of:
(h) notifying said creator client that said guest client has viewed and heard said audio-visual presentation;

3. The method of claim 2 whereby said visual elements comprise digital representations of photographs.

4. The method of claim 3 whereby said audio elements represent digitally recorded files.

5. The method of claim 4 whereby said audio elements are WAV files.

6. The method of claim 5 whereby said audio elements are MPG files.

7. The method of claim 6 whereby said audio elements are MP3 files.

8. The method of claim 7 comprising the additional steps of:
(i) placing an online order for a hard copy of said photographs;
(j) recording a sound file on an audio playback means which is attached to said hard copy of said photograph;
(k) placing an online order for said audio playback means which is attached to said photograph,
whereby a user may obtain a hard copy of said photograph and said audio associated with said photograph for playback by the user without access to the internet.

9. The method of claim 8 whereby said audio elements may be edited before being uploaded.

10. The method of claim 9 whereby said uploading is performed using an Active X control.

11. The method of claim 10 whereby said associating is performed by said client system.

12. The method of claim 11 comprising the additional step of:
(l) editing more than one audio visual element at one time.

13. The method of claim 12 whereby said displayed audio and visual elements may be edited only by said creator client.

14. The method of claim 13 comprising the additional step of:
(m) rearranging the order of said audio visual elements in said audio visual presentation.

15. The method of claim 14 whereby said guest client may perform only steps (g) through (k).

16. The method of claim 15 comprising the additional steps of:
(o) generating a unique URL by said client system for each guest client of claim 11; and,
(p) sending an e-mail to said guest client notifying said guest client that said audio visual presentation may be viewed, said e-mail containing said unique URL in the form of a link from said guest client to said audio visual presentation.

17. The method of claim 16 comprising the additional step of:
(q) linking said guest client to said audio visual presentation when said guest client clicks on said URL link contained in said e-mail from said client system.

18. The method of claim 17 comprising the additional step of:
(q) notifying said creator client that said guest client with said unique URL has viewed said audio visual presentation.
